(19) United States
(12) Patent Application Publication
(10) Pub. No.: US 2013/0284970 A1
(43) Pub. Date: Oct. 31, 2013

(54) HEAT TRANSFER MEDIUM FOR SOLAR THERMAL SYSTEMS

(71) Applicants: Peter Gröppel, Erlangen (DE); Pascal Heilmann, Lauter (DE); Christian Müller-Elvers, Erlangen (DE); Peter Mürau, Furth (DE); Matthias Übler, Ursensollen (DE)

(72) Inventors: Peter Gröppel, Erlangen (DE); Pascal Heilmann, Lauter (DE); Christian Müller-Elvers, Erlangen (DE); Peter Mürau, Furth (DE); Matthias Übler, Ursensollen (DE)

(73) Assignee: SIEMENS AG, Munich (DE)

(21) Appl. No.: 13/978,581

(22) PCT Filed: Dec. 2, 2011
(86) PCT No.: PCT/EP2011/071596

§ 371 Date: Jul. 8, 2013

(30) Foreign Application Priority Data
Jan. 7, 2011 (DE) 10 2011 008 091.0

(51) Int. Cl. C09K 5/12

(52) U.S. Cl. CPC C09K 5/12
USPC 252/71

(57) ABSTRACT

A heat transfer medium for solar thermal systems, a solar salt, contains nitrate salts. By admixing Ba and/or Sr are added to Li—Na—K—NO₃ to improve the properties of the solar salt.

### CROSS REFERENCE TO RELATED APPLICATIONS

This application is based on and hereby claims priority to International Application No. PCT/EP2011/071596 filed on Dec. 2, 2011 and German Application No. 10 2011 008 091.0 filed on Jan.7, 2011, the contents of which are hereby incorporated by reference.

### BACKGROUND

The invention relates to a new heat transfer medium, particularly nitrate salts, for solar thermal systems.

The coming generation of solar thermal power plant systems (concentrating solar power CSP) based on parabolic trough and Fresnel reflector technology, for example, is highly likely to move away from the present organic heat transfer medium, e.g. Therminol VP-1™made by Solutia®, a eutectoid mixture of 73.5 wt. % biphenyl ether and 23.5 wt. % biphenyl with a melting point of 12° C., and toward inorganic media, a trend which is indispensable in terms of power plant design and ongoing efforts to increase efficiency.

An inorganic medium, in particular a molten salt for example, as a heat transfer fluid (HTF) offers a number of advantages which can significantly reduce the break-even time (Levelized Cost of Energy LCOE) of solar thermal CSP systems compared to fossil fuel generation. In particular, high continuous operating temperatures (T>500° C.) are required for the HTF circulating in the solar circuit, as this is the only way of achieving sufficiently high energy densities for maximum utilization of the steam turbine in a water-steam circuit. The efficiency of a turbine is known to be proportional to the temperature of the inflowing gas and/or steam, so that CSP systems must ideally be operated with a circulating HTF that can withstand temperatures of up to 565° C. without thermal decomposition.

However, the melting point of such a medium must be very low, as solidification of the circulating molten salt within the miles of pipework and receiver systems must be prevented at all costs. The higher the melting point of an HTF, the more intensive and complex the precautionary measures must be in order to prevent blockages. In this case, trace heating systems of an electrical and/or thermal nature are used which are designed to ensure a thermal safety margin above the actual melting point in the event of periods of bad weather, maintenance and/or drainage activities.

A salt is a heteropolar compound made up of cations and anions which form a crystal lattice in the solid state.

This mixture can be heated to temperatures of up to 550° C. without thermal degradation and therefore, from a thermodynamic perspective, allows solar energy to be converted into electrical energy much more efficiently than using the above mentioned Therminol which, because of its organic structure, must not exceed a maximum operating temperature of 395° C., as degradation will otherwise occur.

Since a solar thermal power plant produces no energy per se during night-time operation, salt-based sensible and/or latent heat stores have always been used. The most frequently used prior-art mixture for such a purpose is what is known as “solar salt”, a non-eutectoid mixture of 60 wt. % sodium nitrate and 40 wt. % potassium nitrate with a liquidus temperature of approximately 240° C. This mixture is used for thermal energy storage (TES) e.g. for providing heat during the night. For this purpose, in the present generation of CSP systems, during day-time operation some of the collected solar energy is buffered in the molten solar salt via a Therminol-to-salt heat exchanger, to be drawn upon during the night and continue to provide continuous energy for the turbine.

### SUMMARY

One possible object is therefore to provide a replacement for the organic Therminol as the heat transfer medium in solar thermal systems, the melting point of which is as low as possible and whose high-temperature stability is ensured even during continuous operation.

The general insight is that inorganic salt mixtures, especially nitrate salt mixtures, have been found to be particularly suitable for use as a heat transfer medium, because they natively have comparatively low melting points which can be further reduced by binarization, ternarization, quaternarization and quinarization, etc. within the alkali and alkaline earth group of the periodic table by forming corresponding eutectics.

The inventors propose adding a barium and/or strontium nitrate additive to the nitrate salt mixture.

### DETAILED DESCRIPTION OF THE PREFERRED EMBODIMENT

Reference will now be made in detail to the preferred embodiments of the present invention, examples of which are illustrated below.

Accordingly, the subject matter of the proposals is a nitrate salt based heat transfer medium for solar thermal power plant systems comprising potassium and sodium cations, characterized in that the nitrate salt mixture contains barium and/or strontium as additional cations.

Nitrate-based eutectic salt mixtures comprising potassium and sodium cations already exist, containing in particular lithium and/or calcium as additional cations.

For example, a eutectic mixture comprising approximately 21 mol % Ca²⁺, 49 mol % K⁺, and 30 mol % Na⁺and having a low melting point of approximately 132-135° C. is known from the publication of A. G. Bergmann and I. S. Rassonskaya, and N. E. Schmidt in Izvest Sectora “Fiz.-Khim Anal” of the Inst Obshkhei Neorg Khim, Akad Nauk S.S.S.R. 26 (1955), page 156. The problem, however, is that at temperatures above 500° C. the strongly polarizing calcium cations Ca²⁺tend to combine with the available oxygen of the nitrate to form the corresponding oxides that are insoluble in the salt mixture and whose melting point is significantly higher and which tend to form, with moisture, highly corrosive calcium hydroxide.

Here it has been shown that adding barium and/or strontium nitrates impedes the formation of the oxide and hydroxide and therefore improves the durability of the eutectic salt mixture at high temperatures.

The disadvantage of known lithium-containing eutectic nitrate salt mixtures comprising potassium/sodium is that lithium is expensive and also that the lithium-containing eutectic salt mixtures are always strongly hygroscopic. By adding strontium and/or barium instead of lithium it has been possible to greatly reduce the price of the eutectic salt mixtures with no loss of quality. In addition, the strontium and/or barium nitrates do not produce the hygroscopy caused by the lithium nitrate. Lastly, the eutectic salt mixtures with added strontium and/or barium nitrate have a higher density than the corresponding salts with added lithium nitrate.

As an exemplary embodiment, the known Na—K—Ca—NO₃ eutectic salt mixture comprising approximately 21 mol % Ca²⁺, 49 mol % K⁺, and 30 mol % Na⁺with a melting range at around 133° C. was admixed with a quantity of 0.6 mol % barium (2+) cations. A melting temperature reduction of 8° C. could be observed. A completely liquid phase of the salt mixture was only reached at 143° C. in the barium-free state, whereas with barium the liquid phase could be attained as much as 10° C. lower, at 134° C.

To produce a eutectic mixture, in particular an at least ternary mixture (i.e. comprising 3 substances), barium and/or strontium salts in quantities of 0.01 to 30 mol %, preferably of 0.1 to 15 mol %, are used. At the eutectic point, the eutectic, i.e. the mixture, solidifies like a pure substance, preferably without a temperature range.

All the mixtures contain barium and strontium components in quantities of up to 30 mol %, preferably up to 15 mol % barium and/or strontium and with particular preference up to 10 mol % barium and/or strontium. The remaining cations such as Li, Na, K, Ca are in the ranges 10-60 mol %.

Admixing Ba and/or Sr to Li—Na—K—NO₃ (33/21/47 mol % respectively, MP 116° C.) produces an Li—Na—K—Ba/Sr—NO₃ eutectic having an MP<116° C. At the same time, however, the Li content is then reduced, making the mixture cheaper, less hygroscopic and higher in density. The same applies to quaternarization, i.e. a mixture of 4 substances instead of the ternary mixture of 3 substances: calcium, sodium, potassium nitrate (Ca—Na—K—NO₃) to Ca—Na—K—Ba/Sr—NO3. The Ba/Sr content in the quaternary mixture is preferably in the range 0.1-15 mol %. The remaining cations Li, Na, K, Ca are correspondingly reduced pro rata, i.e. always in the range 10-60%, which then adds up to 100%.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. (canceled)

4. A heat transfer medium for solar thermal systems, comprising:
a sodium and potassium nitrate salt mixture; and
barium and/or strontium nitrate additive.

5. The heat transfer medium as claimed in claim 4, wherein the salt mixture also contains lithium and/or calcium nitrate.

6. The heat transfer medium as claimed in claim 4, wherein barium nitrate is present in a quantity of 0.01 to 30 mol %.

7. The heat transfer medium as claimed in claim 4, wherein barium nitrate and/or strontium nitrate is present in a quantity of 0.01 to 15 mol %.

8. The heat transfer medium as claimed in claim 4, wherein barium nitrate and/or strontium nitrate is present in a quantity of 0.01 to 10 mol %.

9. The heat transfer medium as claimed in claim 4, wherein the salt mixture is a sodium-potassium-calcium nitrate salt mixture, and the nitrate additive is barium nitrate.

10. The heat transfer medium as claimed in claim 9, wherein barium nitrate is present in a quantity of 0.01 to 10 mol %.

11. The heat transfer medium as claimed in claim 10, wherein the salt mixture and the nitrate additive form a substantially eutectic mixture.

12. The heat transfer medium as claimed in claim 4, wherein the salt mixture is a sodium-potassium-lithium nitrate salt mixture.

13. The heat transfer medium as claimed in claim 12, wherein the nitrate additive is present in a quantity of 0.01 to 10 mol %.

14. The heat transfer medium as claimed in claim 13, wherein the salt mixture and the nitrate additive form a substantially eutectic mixture.

15. The heat transfer medium as claimed in claim 4, wherein the salt mixture is a sodium-potassium-lithium-calcium nitrate salt mixture.

16. The heat transfer medium as claimed in claim 4, wherein the salt mixture and the nitrate additive form a substantially eutectic mixture.
